(19) United States
(12) Patent Application Publication
(10) Pub. No.: US 2009/0231090 A1
(43) Pub. Date: Sep. 17, 2009

(54) SWITCH APPARATUS

(75) Inventors: CHUN-WEI WANG, Chu-Nan (TW); CHIH-MING LAI, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/347,255

(22) Filed: Dec. 31, 2008

(30) Foreign Application Priority Data
Mar. 14, 2008 (CN) 200810300578.3

(51) Int. Cl. H04B 10/00; G05B 19/00

(52) U.S. Cl. 340/5.1; 398/140

(57) ABSTRACT

An exemplary switch apparatus includes a light signal emitting module and a light signal receiving module. The light signal emitting module includes a code storing unit, a light emitting diode (LED) unit, a driving unit and a power supply. The light signal receiving module includes a light signal converting unit and an electric signal processing unit.

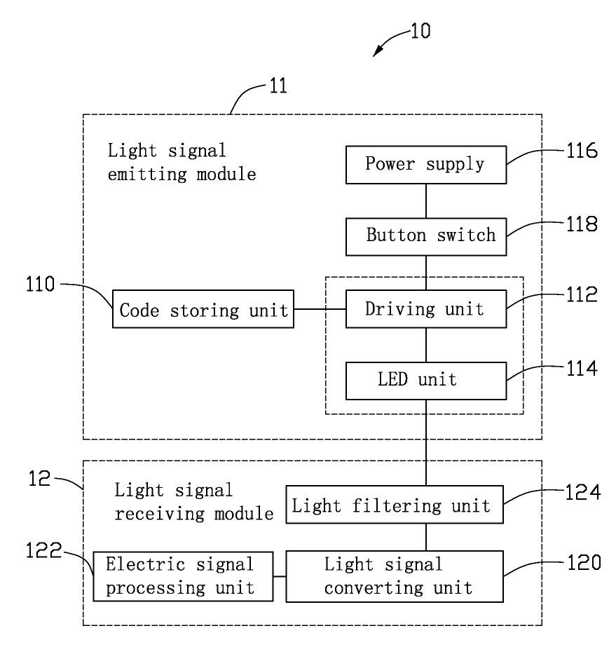

### BACKGROUND

1. Technical Field

The present invention generally relates to a switch apparatus.

2. Discussion of Related Art

Nowadays, switch apparatus different control mechanism of varies kinds, such as speech recognition, fingerprint recognition and iris recognition.

It is known that these switch apparatuses achieve identification of persons by recognizing biological information thereof. However, during the identification process of such switch apparatuses, mass of data is processed complexly. Thereby, hardware with excellent calculating ability is needed in these switches which inevitably increases cost.

Therefore, what is needed is a switch apparatus that overcomes the above described shortcomings.

### BRIEF DESCRIPTION OF THE DRAWINGS

Many aspects of the present switch apparatus can be better understood with reference to the following drawing. The components in the drawings are not necessarily drawn to scale, the emphasis instead being placed upon clearly illustrating the principles of the present apparatus.

The drawing is a schematic view of a switch apparatus, according to an exemplary embodiment.

### DETAILED DESCRIPTION

Reference will now be made to the drawing to describe the embodiment of the present switch apparatus, in detail.

In the drawing, a switch apparatus 10, according to a first embodiment, includes a light signal emitting module 11 and a light signal receiving module 12. In the illustrated embodiment, the light signal receiving module 12 functions as a lock, and the light signal emitting module 11 functions as a key to open the lock.

The light signal emitting module 11 includes a code storing unit 110, a driving unit 112, a light emitting diode (LED) unit 114 and a power supply 116.

The code storing unit 110 is configured for storing a predetermined code. The code storing unit 110 can be a flash memory or an erasable programmable read-only memory (EPROM).

The driving unit 112 is configured for reading the predetermined code stored in the code storing unit 110, generating a pulse signal representing the predetermined code, and driving the LED unit 114 to emit a light signal with the pulse signal. The driving unit 112 can be a LED driving circuit. The driving unit 112 is capable of converting the predetermined code into a pulse signal (pulse voltage or pulse current) according to a first predetermined manner. Corresponding to the predetermined code, the pulse signal has specific pulse width, pulse interval or/and pulse frequency. The predetermined code is associated with the pulse width, pulse interval, pulse frequency of the pulse signal or any combination thereof. When the LED unit 114 is driven by the pulse signal, the light signal emitted from the LED unit 114 represents the predetermined code, due to the specific pulse width, pulse interval or pulse frequency of the pulse signal.

The LED unit 114 includes a single LED or a plurality of LEDs for emitting light of different wavelengths. The LED is capable of emitting visible light or invisible light.

When the LED unit 114 includes a single LED, the driving unit 112 drives the LED unit 114 to emit a light signal with a pulse signal (pulse voltage or pulse current) that has specific pulse width, pulse interval and/or pulse frequency. Due to that the light signal can varies according to different pulse width, pulse interval and/or pulse frequency of the pulse signal. The predetermined code can be represented by a combination of at least two of the pulse width, pulse interval and pulse frequency of the pulse signal.

When the LED unit 114 includes a plurality of LEDs with different light emitting wavelengths, the plurality of LEDs can be driven by the driving unit 112 to alternately emitting lights in a specific sequence. Thereby, the predetermined code is associated with light emitting sequence of the LEDs, different light wavelengths of the LEDs, a pulse width of the pulse signal, a pulse interval of the pulse signal and a pulse frequency of the pulse signal, or any combination thereof. Accordingly, the predetermined code can be represent by light emitting sequence of the LEDs, different light wavelengths of the LEDs, a pulse width of the pulse signal, a pulse interval of the pulse signal and a pulse frequency of the pulse signal, or any combination thereof.

The power supply 116 is electrically connected to the driving unit 112, for providing electrical power to the driving unit 112. In an exemplary embodiment, the power supply 116 is electrically connected to the driving unit 112 via a button switch 118.

The light signal receiving module 12 includes a light signal converting unit 120 and an electric signal processing unit 122.

The light signal converting unit 120 is configure for receiving the light signal emitted by the LED unit 114 and converting the light signal into an electric signal, which represents the predetermined code, according to a second predetermined manner.

The electric signal processing unit 122 is configured for storing a key code, receiving the electric signal and comparing the electric signal with the key code stored therein beforehand. If the electric signal matches the check code, for example “the predetermined code represented by the electric signal is as same as the check code” or “the predetermined code represented by the electric signal and the check code satisfy a specific transformation relationship”, the switch apparatus 10 opens.

Furthermore, the switch apparatus 10 can also includes a light filtering unit 124 for filtering light which is not emitted from the LED unit 114. The light filtering unit 124 can be a filter.

Finally, it is to be understood that the above-described embodiments are intended to illustrate rather than limit the invention. Variations may be made to the embodiments without departing from the spirit of the invention as claimed. The above-described embodiment illustrates the scope of the invention but do not restrict the scope of the invention.

What is claimed is:

1. A switch apparatus, comprising:
a light signal emitting module comprising
a code storing unit for storing a predetermined code,
a light emitting diode (LED) unit,
a driving unit for reading the predetermined code stored in the code storing unit,
generating a pulse signal representing the predetermined code and driving the LED unit to emitting a light signal with the pulse signal, and
a power supply for providing electrical power to the driving unit;
a light signal receiving module comprising
a light signal converting unit for receiving and converting the light signal emitted from the LED unit into an electronic signal, and
an electric signal processing unit for storing a key code, receiving the electronic signal and comparing the electronic signal with the key code stored therein.

2. The switch apparatus according to claim 1, further comprising a button switch, wherein the power supply is electrically connected to the driving unit via the button switch.

3. The switch apparatus according to claim 1, wherein the code storing unit is a flash memory or an erasable programmable read-only memory.

4. The switch apparatus according to claim 1, wherein the predetermined code is associated with a pulse width of the pulse signal, a pulse interval of the pulse signal, a pulse frequency of the pulse signal or any combination thereof.

5. The switch apparatus according to claim 1, wherein the LED unit comprises a plurality of LEDs for emitting light of different wavelengths.

6. The switch apparatus according to claim 5, wherein the predetermined code is associated with light emitting sequence of the LEDs, different light wavelengths of the LEDs, a pulse width of the pulse signal, a pulse interval of the pulse signal, a pulse frequency of the pulse signal, or any combination thereof.

7. The switch apparatus according to claim 1, further comprising a light filtering unit for filtering light which is not emitted from the LED unit.
